(19) United States
(12) Patent Application Publication
(10) Pub. No.: US 2008/0279621 A1
(43) Pub. Date: Nov. 13, 2008

(54) Device for Connecting Two Elements

(76) Inventor: Jerome Chaupin, Echirolles (FR)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/885,690

(22) PCT Filed: Mar. 2, 2006
(86) PCT No.: PCT/EP2006/001892

§ 371 Date: Apr. 30, 2008

(30) Foreign Application Priority Data
Mar. 25, 2005 (FR) 05/02969

(51) Int. Cl. F16B 17/00

(52) U.S. Cl. 403/345

(57) ABSTRACT

The invention relates to a connection device (10) comprising: a socket end (12), a spigot end (11) which is intended to be inserted into the socket end (12) and a locking member (18) which is intended to hold the spigot end (11) in the socket end (12) once they have been connected. The locking member (18) is shaped in the form of a staple comprising a head with two side arms. The spigot end (11) comprises an actuating cone which is used to lift the locking member (18) and to position the spigot end (11) between the arms of the locking member (18). The locking member (18) preferably comprises a deformable tongue on each side arm. The deformable tongues form elastic return means which return the locking member (18) to the locked position and block the spigot end (11) in the socket end (1) in the end-of-insertion position.

### TECHNICAL FIELD OF THE INVENTION

The invention relates to a device for connecting two elements, comprising:
a female end, connected to the first element to be connected,
a male end, connected to a second element to be connected and intended to be inserted into the female end,
a locking member in the form of a staple having a head and two lateral arms and intended to hold the male end in the female end after connection.

The invention applies in particular to elements such as lines for carrying fluids.

### PRIOR ART

There are two principal known types of connecting devices for attaching a male end of a first element, such as a hose, to a female end of a second element, such as another hose of larger diameter.

A first example of a connecting device uses a locking element in the form of a wire. The document U.S. Pat. No. 5,000,614 in particular describes a locking member in the form of a pin, with a head extended by two arms. The male end is inserted into the female end and the arms of the pin lock the male end inside the female end, through recesses made in the walls of the female end.

However, such a pin is difficult to manipulate and can be lost when assembling the two ends. The mechanical strength of the connecting device is weak because the arms of the pin are easily deformed. Moreover, the head of the pin projects from the connecting device after assembly of the male end in the female end, which makes it bulky.

Another example of a known connecting device uses a locking member in the form of a staple. The document FR-A-2795156 describes in particular a staple having a head, enclosing a first female element, and two flexible arms intended to hold a male element inserted into the female element. To insert the male element, the head of the staple is pressed to cause the arms to spread and allow the male element to pass. By releasing the head of the staple, the arms retighten on the male element and hold it in the female element.

However, this type of staple requires manual intervention to perform the connection. The staple proves to be easily removable and can easily be lost during assembly of the male element in the female element or its removal therefrom. Furthermore, the mechanical strength of the connecting device is weak because the staple is too flexible.

### OBJECT OF THE INVENTION

A purpose of the invention is to remedy the above-mentioned disadvantages, and an object is a connection device of high mechanical strength that makes it possible quickly and easily to assemble a male end in a female end while ensuring an optimal locking of the male end in the female end after connection.

The object of the invention is characterized in that the connecting device comprises:
means of actuating the locking member, which means are associated with the male end and intended to cooperate with the locking member, so that the insertion of the male end in the female end causes the positioning of the male end between the arms of the locking member,
means of elastic return, which means are associated with the locking member in order to cooperate with the female end, so that the locking member automatically locks the positioning of the male end in the female end, at the end of insertion of the male end.

According to one development of the invention, said actuating means comprise an actuating cone integral with the male end and intended to come into contact with a lower edge of the head of the locking member, in order to cause the lifting of the locking member during the insertion of the male end.

According to another development of the invention, said elastic return means comprise at least a deformable tongue, integral with one corresponding arm of the locking member and intended to move along a corresponding sliding surface during the insertion of the male end into the female end.

Such a connecting device, with means for actuating the locking member and elastic return means making possible an automatic locking of the male end in the female end, therefore allows the two ends to be connected and locked simultaneously simply by an axial insertion of the male end into the female end.

According to a preferred form of embodiment, each deformable tongue comprises a fixed end integral with the corresponding arm of the locking member and one rounded free end sliding on the respective sliding surface. The female end includes at least a locking notch associated with each sliding surface and intended to hold the corresponding deformable tongue of the locking member in a releasing position allowing the removal of the male end from the female end.

Such a system for locking the locking member makes it possible to remove the male end from the female end easily by a simple axial translatory movement in the direction opposite to the direction of insertion of the male end.

### BRIEF DESCRIPTION OF THE DRAWINGS

Other advantages and characteristics will emerge more clearly from the following description of particular forms of embodiment of the invention given by way of non-limiting example, and represented in the attached drawings in which:

FIG. 1 represents a first particular form of embodiment of a connecting device according to the invention, with the male end awaiting insertion into the female end.

FIG. 2 represents an exploded view of the different elements comprising the female end of the connecting device according to FIG. 1.

FIG. 3 represents the female end according to FIGS. 1 and 2, awaiting connection with the male end.

FIG. 4 is an enlarged partial view of part of the female end according to FIG. 3, illustrating different possible positions of the locking member inside the female end.

FIG. 5 is a partial cross sectional view along the axis A-A of the female end according to FIG. 3.

FIG. 6 represents an enlarged partial view of part of the female end according to FIG. 5, illustrating the locking of the locking member in the female end.

FIGS. 7 and 8 represent, respectively, a view in perspective and a partial view, in cross section along axis B-B, of the connecting device according to FIG. 1, with the male end in the process of being inserted into the female end prior to locking.

FIGS. 9 and 10 represent, respectively, a view in perspective and a partial view in cross section along the axis C-C, of the connecting device according to FIGS. 1, 7 and 8, with the male end locked in the female end.

FIG. 11 is a view in partial cross section of a variation of embodiment of a connecting device according to the invention.

FIG. 12 is a variation of embodiment of the locking member of another particular form of embodiment of a connecting device according to the invention.

### DESCRIPTION OF PARTICULAR FORMS OF EMBODIMENT

With reference to the figures, the connecting device 10 comprises a male end 11 connected to a first element (not shown), for example a hose for carrying fluid, and intended to be snapped into a female end 12 connected to a second element (not shown), for example another hose for carrying fluid.

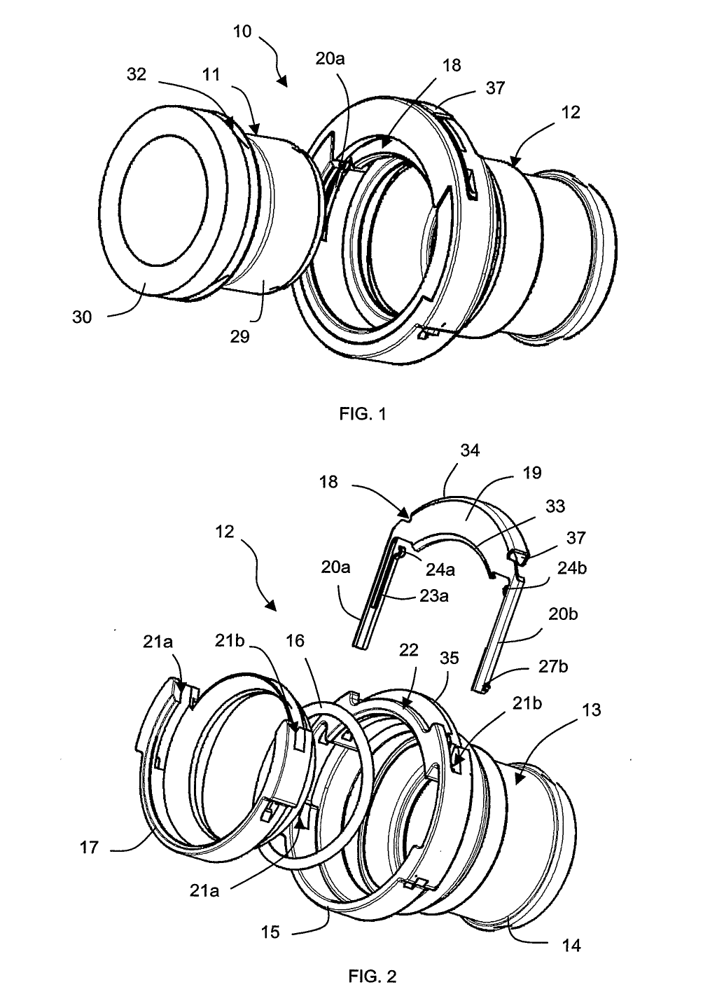

In FIG. 1, the male end 11 and the female end 12 preferably are generally appreciably tubular in shape and are intended to be assembled by coaxial insertion of the male end 11 into the female end 12. The male end 11 and the female end 12 can be made of metal or plastic materials.

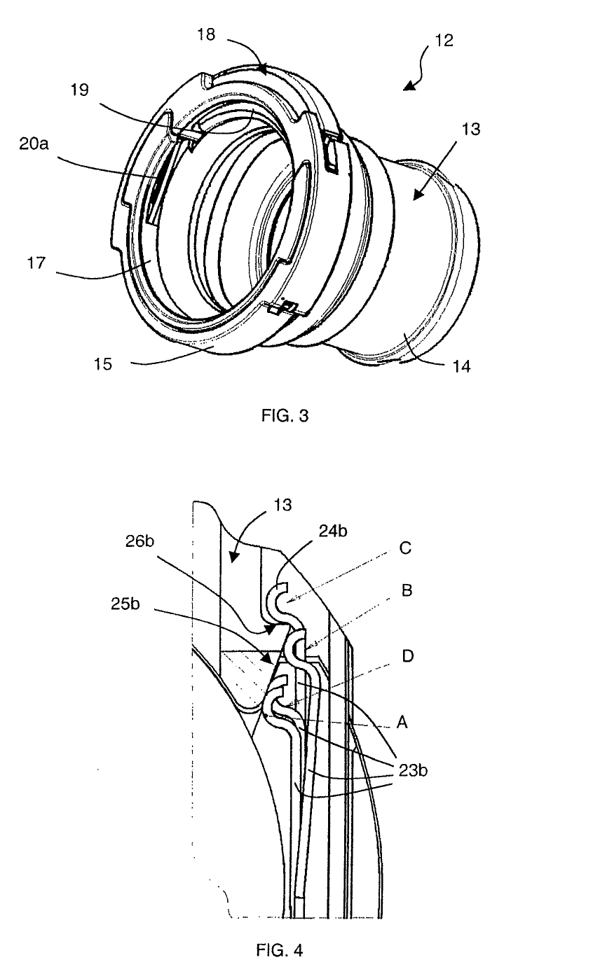

In FIGS. 2 and 3, the female end 12 comprises a main body 13 having a first end 14 integral with the element to be connected, and a connection end 15 cooperating with the male end 11 and having a cross section greater than the cross section of the first end 14.

The female end 12 comprises at least a gasket 16 (FIG. 2), placed inside a groove made in the connection end 15 of the body 13. In particular, the gasket 16 ensures the seal of the connecting device 10 when a connection is made between two lines for carrying fluid.

The female end 12 preferably includes a guide ring 17, intended to hold the gasket 16 in the body 13 as well as to guide the male end 11 when it is inserted into the female end 12. In the particular form of embodiment of the connecting device 10, represented in FIGS. 1 to 3, the connection end 15 of the body 13 and the guide ring 17 have complementary shapes so that they may fit perfectly together and form a uniform collar suitable for receiving the male end 11 (FIG. 3).

The female end 12 also has a locking member 18 placed in the connection end 15 of the body 13 of the female end 12 (FIG. 3). The locking member 18 is intended to allow the quick assembly of the male end 11 in the female end 12, as well as to lock the male end 11 in the female end 12 at the end-of-insertion of the male end 11 in the female end 12.

By way of example, the locking member 18 is obtained by cutting and bending strip steel or sheet metal of predetermined thickness, to form a single piece appreciably in staple form, as represented in FIG. 2.

The locking member 18 includes a head 19, appreciably circular in shape, appreciably following the shape of the connection end 15 of the body 13 (FIGS. 1 and 3), and two parallel lateral arms 20a, 20b. The head 19 and the arms 20a, 20b are intended to cooperate with the male end 11 when it is inserted into the female end 12 (FIG. 1).

The body 13 of the female end 12 has lateral receptacles 21a, 21b, respectively, for the arms 20a, 20b of the locking member 18, and a recess 22 (FIG. 2) for the head 19 of the locking member 18. In the case of a female end 12 having a guide ring 17, said ring also has receptacles 21a, 21b to receive the arms 20a, 20b of the locking member 18 (FIG. 2). The receptacles 21a, 21b act as guide and slide rails for the arms 20a, 20b of the locking member 18 when the locking member 18 is lifted as a result of the insertion of the male end 11, as shown in FIGS. 8 and 10.

In FIG. 3, the locking member 18 is in the rest position, waiting for the insertion of the male part 11. The head 19 of the locking member 18 protrudes into the orifice formed by the connection end 15.

In FIGS. 2 and 4, each lateral arm 20a, 20b preferably has a deformable tongue 23a, 23b, precut in the respective lateral arm 20a, 20b. Each deformable tongue 23a, 23b has a fixed lower end, integral with the respective lateral arm 20a, 20b, and an upper free end equipped with a rounded part 24a, 24b, preferably hook shaped. In the particular form of embodiment of the locking member 18 represented in FIGS. 2 and 4, the curved parts 24a, 24b of the hooks face toward the space delimited by the two lateral arms 20a, 20b of the locking member 18.

In FIG. 4, where only the references relative to the deformable tongue 23b are shown, the curved part 24a, 24b of each hook slides along a sliding surface 25a, 25b, integral with the body 13 of the female end 12, during the insertion of the male end 11. The sliding surfaces 25a, 25b are situated in the connection end 15 of the body 13 of the female end 12 (FIG. 2).

The slope of the sliding surfaces 25a, 25b is calculated in advance so that the deformable tongues 23a, 23b pass from a first position A (FIG. 4) at the lower end of the sliding surfaces 25a, 25b, to a second position B (FIG. 4) at the upper end of the sliding surfaces 25a, 25b. The position A corresponds to the rest position of the locking member 18, prior to the insertion of the male end 11 (FIGS. 1 and 3), in which the deformable tongues 23a, 23b are not under stress and are parallel to the lateral arms 20a, 20b of the locking member 18. Position B corresponds to the position of insertion of the male end 11, prior to its being locked in the female end 12 (FIG. 8). This position B corresponds to the position of maximum deformation of the deformable tongues 23a, 23b.

After the position B, the deformable tongues 23a, 23b move to a position D, between the positions A and B, corresponding to the end-of-insertion position of the male end 11, i.e., the position in which the male end 11 is locked in the female end 12. The position D corresponds to the final position of the locking member 18, in which the locking member 18 overlaps the male end 11. The locking position D is different from the rest position A and the deformable tongues 23a, 23b remain slightly under stress in the locking position of the male end 11 (FIG. 4), because the male end 11 prevents the return of the locking member 18 to its initial rest position A.

The sliding surfaces 25a, 25b are extended, respectively, by locking notches 26a, 26b intended to hold the locking member 18 in the locked position C (FIG. 4). The locking notches 26a, 26b comprise stabilization points of the locking member 18, making it possible to freely disengage the male end by a simple axial translatory movement in the direction opposite to the direction of insertion of the male end 11. In this position C, the locking member 18 no longer holds the male end 11, which can then be freely removed from the female end 12.

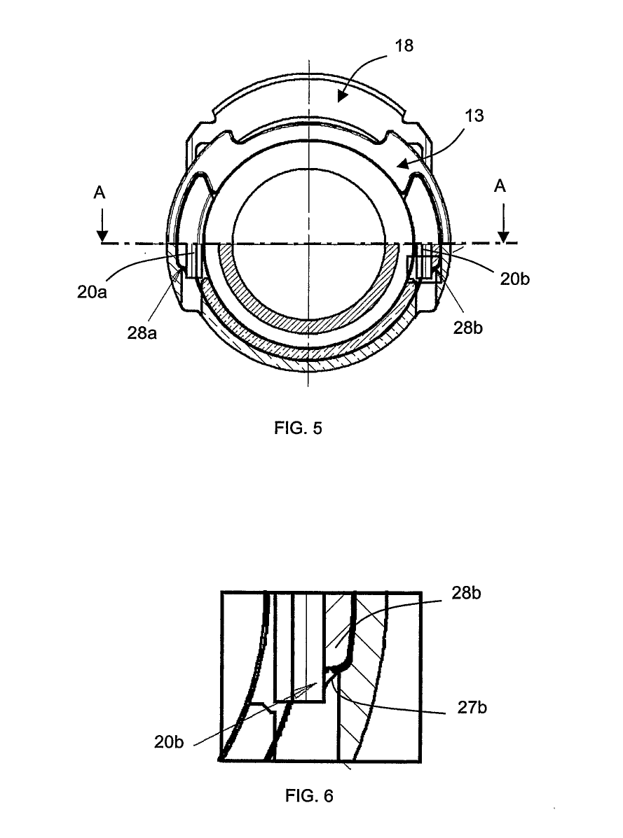

In FIGS. 2, 5 and 6, the locking member 18 has catch teeth 27a, 27b, preferably made on each lateral arm 20a, 20b (FIG. 2). The catch teeth 27a, 27b are oriented, for example, in opposition with respect to the curved parts 24a, 24b of the hooks, at the exterior of the lateral arms 20a, 20b. They cooperate with lateral stops 28a, 28b respectively, which are integral with the body 13 of the female end 12 (FIGS. 5 and 6).

In FIG. 5, the locking member 18 is in the maximum raised position in which the catch teeth 27a, 27b press against the stops 28a, 28b and prevent the locking member 18 from being removed from the female end 12 (FIG. 6). The locking member 18 is therefore pre-assembled irremovably in the female end 12, prior to insertion of the male end 11, which prevents any risk of loss of the locking member 18.

In FIGS. 1, 8 and 10, the male end 11 has a first connecting end 29 intended to be inserted in the connection end 15 of the female end 12, and a second free end 30, connected to the element to be connected and of larger cross section than the cross section of the connection end 29.

The male end 11 has an actuating cone 31, integral with the connection end 29 (FIGS. 8 and 10) and intended to actuate the locking member 18 in order to cause its sliding in the receptacles 21a, 21b.

The male end 11 has at least a retaining groove 32 placed at the free end 30 of the male end 11 and intended to receive the head 19 of the locking member 18 in the locking position (FIG. 10). As shown in FIGS. 8 and 10, the groove 32 is adjacent to the actuating cone 31 so that the locking member 18 automatically goes into its locked position, at the end-of-insertion of the male end 11, just after going past the top of the actuating cone 31.

The head 19 of the locking member 18 comprises a lower edge 33 on which the actuating cone 31 is supported (FIG. 8), during the insertion of the male end 11. The lower edge 33 is preferably rounded so that it does not wear the male end 11, particularly in the case when the male end 11 is made of plastic materials. The lower edge 33 has an appreciably circular shape, following the shape of the outside diameter of the male end 11 in order to optimize the insertion of the male end 11 and the sliding of the locking member 18.

The head 19 of the locking member 18 also comprises an upper edge 34, comprising at least a curved strip 37, in order to cooperate with a retaining collar 35 projecting from the connection end 15 of the body 13 of the female end 12. The upper edge 34, curved around the collar 35, makes it possible to ensure an optimal resistance to extraction for the locking member 18 in the event of unexpected stresses during removal of the male end 11.

The curved strip 37 can extend over the whole length of the upper edge 34, as shown in FIG. 2, or over only a portion of the upper edge 34, as shown in FIGS. 1, 7 and 9. By way of example, the curved strip 37 extends appreciably over one eighth of the length of the upper edge 34.

The assembly of the male end 11 in the female end 12, with locking of the male end 11 at the end of insertion, will now be described in more detail with reference to FIGS. 1 and 7 to 10. In FIG. 1, the locking member 18 is in the rest position in the female end 12 and the deformable tongues 23a, 23b are in their rest position, parallel to the lateral arms 20a, 20b (FIG. 2), in the position A of FIG. 4.

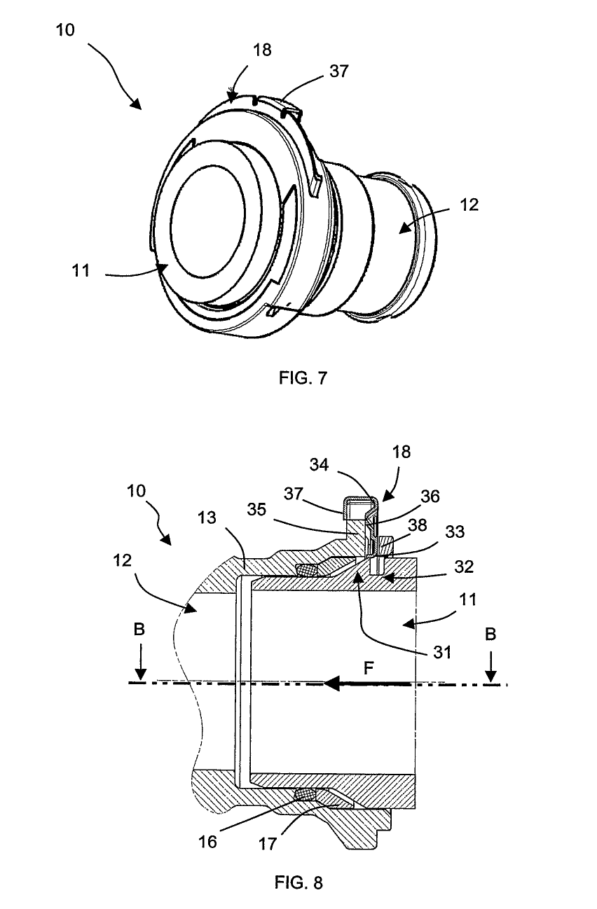

In FIGS. 7 and 8, the male end 11 is inserted, along arrow F, into the female end 12 and the actuating cone 31 causes the locking member 18 to rise, by contact on the lower edge 33 of the head 19 (FIG. 8). The arms 20a, 20b of the locking member 18 slide in the receptacles 21a, 21b of the female end 12 and the deformable tongues 23a, 23b slide along the sliding surfaces 25a, 25b of the female end 12 to reach the insertion position B of FIG. 4. The male end 11 is positioned between the lateral arms 20a, 20b which remain parallel to each other when the locking member 18 is raised. The deformable tongues 23a, 23b are stressed to the maximum (FIG. 4).

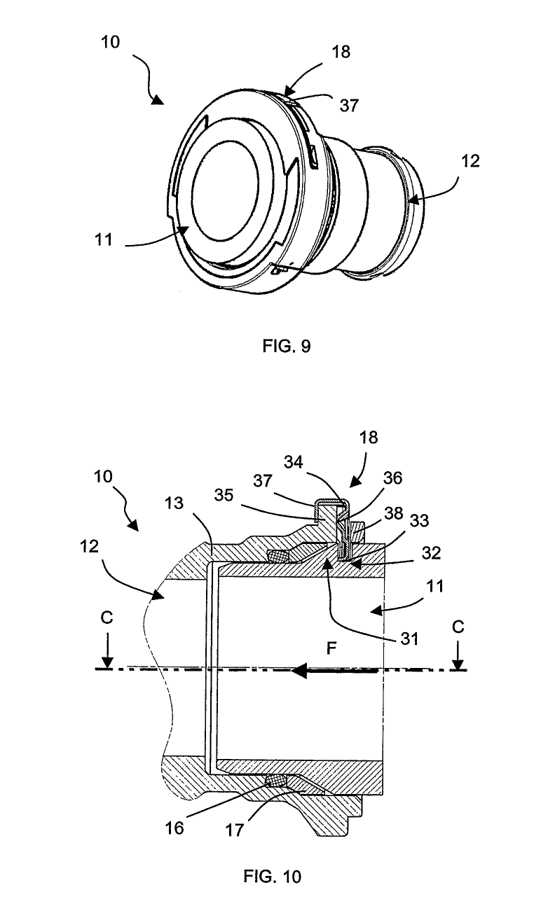

In FIGS. 9 and 10, the male end 11 is positioned at the end of insertion in the female end 12. The lower edge 33 of the head 19 has gone past the top of the actuating cone 31 and is fitted into the retaining groove 32 of the male end 11. The locking member 18 is in its final locking position, position D of FIG. 4, as a result of the elasticity of the deformable tongues 23a, 23b, that have slid in the opposite direction along the sliding surfaces 25a, 25b (FIG. 10).

The locking member 18 now overlaps the male end 11 and the upper edge 34 covers the collar 35 of the body 13, in order to prevent any unexpected extraction of the male end 11. The lower edge 33 of the head 19 of the locking member 18 is in contact with the bottom of the groove 32 of the male end 11, to ensure an optimal securing of the locking member 18 in the male end 11. The upper edge 34 covers the collar 35 while leaving a small amount of residual play, thus ensuring optimal resistance to extraction.

In this locked position (FIG. 10), the male end 11 is not in contact with the bottom of the female end 12. The end-of-insertion position of the male end 11 corresponds to its locking by the locking member 18 and not to its having reached the bottom of the female end 12. Thus the residual space between the two ends 11, 12 is a safety means that makes it possible to verify whether the male end 11 is properly locked in place or just inserted against the bottom of the female end 12.

The assembly of the male end 11 in the female end 12 is therefore accomplished by a simple axial translatory movement and the locking of the male end 11 inside the female end 12 is done automatically by the locking member 18.

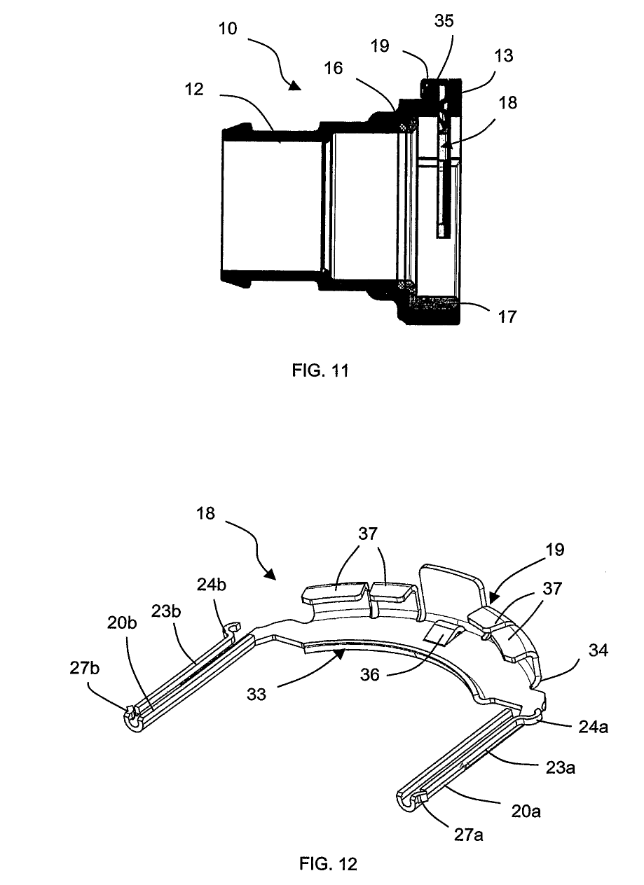

In the variation of form of embodiment of the connecting device 10 shown in FIG. 11, as well as in FIGS. 1 to 3, 7 and 9, the body 13 of the female end 12 completely encompasses the locking member 18 in rest position and/or end-of-insertion position of the male end 11. The compactness of the connecting device 10 and the resistance to extraction of the locking member 18 are therefore optimized.

Such a connecting device 10 thus makes it possible to simultaneously assemble and automatically lock the male end 11 in the female end 12 by a simple axial translatory movement. The removal of the male end 11 is also done easily thanks to the locking notches 26a, 26b of the female end 12, which make it possible to release the locking of the male end 11.

The connecting device 10 has good mechanical strength, particularly as a result of the irremovable metal locking member 18 of which only the deformable tongues 23a, 23b can be deformed. Moreover, the resistance to temperature of the locking member 18 is good and the resistance to extraction of the connecting device 10 is ensured, among other things, by the upper edge 34 of the head 19 of the locking member 18, overlapping the collar 35 of the female end 12. As shown in FIGS. 8 and 10, the body 13 of the female end 12 can optionally comprise a circular flange 38 forming a stop, intended to block the locking member 18 and to ensure optimal resistance to extraction.

The invention is not limited to the different forms of embodiment described above. The shape of the locking member 18, of the female end 12 and the male end 11 can be different, as long as the locking member 18 is actuated by the male end 11 during its insertion and it automatically locks the male end 11 in the female end 12 at the end of insertion.

The female end 12 can include several gaskets 16, [and] the locking member 18 can be obtained by a drawing process. The male end 11 can include two retaining grooves 32 that are symmetrical with respect to the axis C-C (FIG. 10).

In the variation of embodiment of the locking member 18, shown in FIG. 12, the deformable tongues 23a, 23b can be oriented in the other direction, toward the outside of the space delimited by the lateral arms 20a, 20b. The sliding surfaces 25a, 25b (not shown in FIG. 12) associated with the female end 12 are then oriented complementarily and the catch teeth 27a, 27b are oriented in the same direction as the curved parts 24a, 24b of the deformable tongues 23a, 23b. The elastic return of the locking member 18 is accomplished in the same way by deformation of the deformable tongues 23a, 23b which slide along the sliding surfaces 25a, 25b.

Moreover, the upper edge 34 of the head 19 can include several curved strips 37 placed side by side and cooperating with the retaining collar 35 of the female end 12, in order to optimize the resistance to extraction. The head 19 can also include a projection 36 (FIGS. 8, 10 and 12) to optimize the resistance to extraction in the event of deformation of the locking member 18.

Such a connecting device 10, with automatic locking of the male end 11 in the female end 12, can be used in particular in all domains needing the connection of hoses that carry fluid, principally for the automobile industry.

1. Connecting device (10) of two elements comprising:
a female end (12), connected to the first element to be connected,
a male end (11), connected to the second element to be connected and intended to be inserted in the female end (12),
a locking member (18) in the shape of a staple having a head (19) and two lateral arms (20a, 20b) and intended to hold the male end (11) in the female end (12) after connection,
connecting device characterized in that it comprises:
means (31, 33) of actuating the locking member (18), which means are associated with the male end (11) and intended to cooperate with the locking member (18), so that the insertion of the male end (11) in the female end (12) causes the positioning of the male end (11) between the arms (20a, 20b) of the locking member (18),
means (23a, 23b; 25a, 25b) of elastic return, which means are associated with the locking member (18) in order to cooperate with the female end (12), so that the locking member (18) automatically locks the positioning of the male end (11) in the female end (12), at the end of insertion of the male end (11).

2. Connecting device according to claim 1, characterized in that the said actuating means comprise an actuating cone (31) integral with the male end (11) and intended to come into contact with a lower edge (33) of the head (19) of the locking member (18), in order to cause the lifting of the locking member (18) during the insertion of the male end (11).

3. Connecting device according to claim 2, characterized in that the lower edge (33) of the head (19) of the locking member (18) is rounded.

4. Connecting device according to claim 2, characterized in that the female end (12) has receptacle grooves (21a, 21b) intended to receive the arms (20a, 20b) of the locking member (18), said grooves (21a, 21b) acting as slide rails during the actuating of the locking member (18).

5. Connecting device according to claim 1, characterized in that said elastic return means comprise at least a deformable tongue (23a, 23b), integral with one corresponding arm (20a, 20b) of the locking member (18) and intended to move along a corresponding sliding surface (25a, 25b) during the insertion of the male end (11) into the female end (12).

6. Connecting device according to claim 5, characterized in that each deformable tongue (23a, 23b) has a fixed end integral with the corresponding arm (20a, 20b) of the locking member (18) and a curved free end (24a, 24b) sliding on the corresponding sliding surface (25a, 25b).

7. Connecting device according to claim 5, characterized in that each sliding surface (25a, 25b) is integral with the female end (12) and has a predetermined slope to ensure the elastic return of the corresponding deformable tongue (23a, 23b), in the end-of-insertion position of the male end (11).

8. Connecting device according to claim 5, characterized in that the female end (12) has at least one locking notch (26a, 26b) associated with each sliding surface (25a, 25b) and intended to hold the corresponding deformable tongue (23a, 23b) of the locking member (18) in an unlocked position (C) permitting the removal of the male end (11) from the female end (12).

9. Connecting device according to claim 1, characterized in that the male end (11) has at least a retaining groove (32) in which the head (19) of the locking member (18) is automatically positioned in the end-of-insertion position of the male end (11).

10. Connecting device according to claim 1, characterized in that the head (19) of the locking member (18) has an upper edge (34) having at least one curved strip (37) intended to cooperate with a retaining collar (35) projecting from the female end (12).

11. Connecting device according to claim 1, characterized in that the female end (12) has lateral stops (28a, 28b) cooperating with catch teeth (27a, 27b) integral with the free ends of the lateral arms (20a, 20b) of the locking member (18).

12. Connecting device according to claim 1, characterized in that the locking member (18) is obtained by cutting and bending sheet metal or strip steel of a predetermined thickness.

13. Connecting device according to claim 3, characterized in that the female end (12) has receptacle grooves (21a, 21b) intended to receive the arms (20a, 20b) of the locking member (18), said grooves (21a, 21b) acting as slide rails during the actuating of the locking member (18).

14. Connecting device according to claim 2, characterized in that said elastic return means comprise at least a deformable tongue (23a, 23b), integral with one corresponding arm (20a, 20b) of the locking member (18) and intended to move along a corresponding sliding surface (25a, 25b) during the insertion of the male end (11) into the female end (12).

15. Connecting device according to claim 3, characterized in that said elastic return means comprise at least a deformable tongue (23a, 23b), integral with one corresponding arm (20a, 20b) of the locking member (18) and intended to move along a corresponding sliding surface (25a, 25b) during the insertion of the male end (11) into the female end (12).

16. Connecting device according to claim 6, characterized in that each sliding surface (25a, 25b) is integral with the female end (12) and has a predetermined slope to ensure the elastic return of the corresponding deformable tongue (23a, 23b), in the end-of-insertion position of the male end (11).

17. Connecting device according to claim 6, characterized in that the female end (12) has at least one locking notch (26a, 26b) associated with each sliding surface (25a, 25b) and intended to hold the corresponding deformable tongue (23a, 23b) of the locking member (18) in an unlocked position (C) permitting the removal of the male end (11) from the female end (12).

18. Connecting device according to claim 7, characterized in that the female end (12) has at least one locking notch (26a, 26b) associated with each sliding surface (25a, 25b) and intended to hold the corresponding deformable tongue (23a, 23b) of the locking member (18) in an unlocked position (C) permitting the removal of the male end (11) from the female end (12).
